(19) United States
(12) Patent Application Publication
(10) Pub. No.: US 2022/0340495 A1
(43) Pub. Date: Oct. 27, 2022

(54) FRICTION STIR WELDING USING A PCBN-BASED TOOL CONTAINING SUPERALLOYS

(71) Applicant: Element Six (UK) Limited, Oxtordshire (GB)

(72) Inventors: Santonu GHOSH, Oxfordshire (GB); Teresa RODRIGUEZ SUAREZ, Oxfordshire (GB)

(21) Appl. No.: 17/763,273

(22) PCT Filed: Nov. 25, 2020
(86) PCT No.: PCT/EP2020/083395

§ 371 Date: Mar. 24, 2022

(30) Foreign Application Priority Data
Dec. 19, 2019 (GB) 1918892.9

(51) Int. Cl. C04B 35/5831; C04B 35/645; B23K 20/12; C22C 29/16; C22C 27/04; C22C 1/05

(52) U.S. Cl. CPC C04B 35/5831; C04B 35/645; B23K 20/1255; C22C 29/16; C22C 27/04; C22C 1/051; C04B 2235/386; C04B 2235/404; C04B 2235/604; C04B 2235/656; C04B 2235/6581; C04B 2235/661

(57) ABSTRACT

This disclosure relates to a polycrystalline cubic boron nitride, PCBN, composite material comprising cubic boron nitride, cBN, particles and a binder matrix material in which the cBN particles are dispersed. The binder matrix material comprises one or more superalloys.

### FIELD OF THE INVENTION

This disclosure relates to a composite material comprising a binder matrix material including a superalloy and cubic boron nitride (cBN) particles, which are formed together under high pressure and high temperature (HPHT) conditions. The disclosure further relates to the application of the composite material as a probe or tool material for friction stir welding of steels, nickel alloys and other high melting point alloys, and to probes which have much higher performance than existing probes in terms of reduced wear and fracture. In particular, the disclosure relates to reducing the cost of the composite material.

### BACKGROUND

Friction stir welding (FSW) is a technique whereby a rotating tool is brought into forcible contact with two adjacent workpieces to be joined and the rotation of the tool creates frictional and viscous heating of the workpieces. Extensive deformation as mixing occurs along a plastic zone. Upon cooling of the plastic zone, the workpieces are joined along a welding joint. Since the workpiece remains in the solid phase this process is technically a forging process rather than a welding process, none the less by convention, it is referred to as welding or friction stir welding and that convention is followed here.

In the case of FSW in low temperature metals, the whole tool/tool holder can be a single piece of shaped tool steel, in which case it is often referred to as a ‘probe’. In the case here where the tool is for welding higher temperature alloys such as steel, the tool is often in two or more parts, with an end element that is in direct contact with the material being welded, often referred to as a ‘puck’ or ‘tool insert’, and the remainder of the tool being the ‘tool holder’ which holds the puck securely and which fits into the FSW machine, so that the tool puck and tool holder together make up the ‘tool’ or ‘tool assembly’. The tool puck is typically shaped to form a shoulder and a stirring pin, often with a reverse spiral cut into the surface so that during rotation it pulls metal towards the pin and pushes this down into the hole being formed by the pin.

In general, FSW operations comprise a number of steps, for example:
a) an insertion step (also known as the plunge step), from the point when the tool comes into contact with the workpieces to the point where the pin is fully embedded up to the shoulder 20 in the heated and softened workpieces,
b) a tool traverse, when the tool moves laterally along the line in between the workpieces to be joined, and
c) an extraction step, when the tool is lifted or traversed out of the workpieces.

The tool traverse, which is the stage primarily forming the weld, is usually performed under constant conditions; typically these conditions are rotational speed, conditions of the plunge, speed of traverse etc.

The FSW method was pioneered by The Welding Institute (TWI) in 1991 and is described in WO 93/10935. TWI have licensed the technology and although it is mostly used to weld together parts made of aluminium (Al) alloys, it is also used for other low melting point metals such as copper (Cu), lead (Pb) and magnesium (Mg).

WO 2004/101205 claims an FSW tool comprising, inter cilia, a superabrasive material manufactured under high-pressure high-temperature (HPHT) conditions. Specifically, polycrystalline diamond (PCD) and polycrystalline boron nitride (PCBN) are claimed.

General Electric have filed a patent application (US 2004/238599 A1) directed to using tungsten-based refractory metal alloys for the FSW of steels and other materials.

FSW is a well-established method for joining metals. However, it is currently typically only suitable for metals with a relatively low melting point owing to the requirement that the FSW tool or probe material retains its essential properties at the joining temperature and does not chemically interact with the joined metals. It is for this reason that the joining of steels and other high melting point metals by means of FSW is not feasible using steel probes, such as are used in the case of the lower melting point metals like Al & Cu.

There has been a recent drive to develop an FSW probe using a material that retains its essential properties and form at temperatures above 1000° C. in a ferrous environment, in order to make the FSW joining of steels and other high melting point metals technically and commercially feasible. Suitable tools have been difficult to develop due at least in part to the temperatures but also due to the loads that the tool is subjected to during the process. These tools generally have been found to have a limited life cycle. Moreover, these tools are often fabricated from expensive materials which are difficult to shape, and consequently the tools are costly. Currently, the lifespan of such tools is often measured in terms of metres of welding per tool, and the cost of using the tool measured in terms of $, USD per metre, the tool cost divided by the tool life in metres. Despite knowledge of the many benefits of friction stir welding in steels since the early 2000's or earlier, its use has been very limited since currently available tools are considered expensive, and unreliable and limited in life.

The use of polycrystalline cubic boron nitride (PCBN) made using the HPHT approach, as a probe material, for example, has been described in the art. There has also been substantial research into the use of W, Re, Mo, including their alloys and other refractory metals. Both of these approaches (PCBN & refractory metal) have different disadvantages:
While the PCBN is far more wear resistant than necessary for this application, its fracture toughness is lower than ideally required. The application involves plunging the probe into the work piece(s) at the join between two such pieces, when the work piece is initially cold and the point of contact between work piece and tool relatively small. This step thus involves high forces and rapid heating, and can severely stress and damage the tool. During the subsequent traverse, the tool is also subject to substantial cyclic forces, as the tool is also being rotated, which can drive crack propagation
While refractory metals such as W, Mo and Re have sufficient fracture toughness, they lack the wear resistance required for a commercially feasible probe, and their principal failure mechanism is wear. Even more importantly, probes made from such metals tend to distort in form during application.

There is a longstanding need for materials that combine the toughness and strength of W, Mo or Re with the enhanced wear resistance of PCBN, while retaining the substantial chemical inertness and form required during the FSW application.

There is also a need to reduce the cost of the tool without compromising the requisite material performance.

### SUMMARY OF THE INVENTION

In a first aspect of the invention, there is provided a polycrystalline cubic boron nitride, PCBN, composite material comprising:
between 70 and 95 vol. % cubic boron nitride, cBN, particles and
between 30 and 5 vol. % binder matrix material in which the cBN particles are dispersed, the binder matrix material comprising one or more superalloys.

Preferable and/or optional features of the first aspect of the invention are provided in dependent claims 2 to 7.

In a second aspect of the invention, there is provided a tool for friction stir welding, said tool comprising a body portion comprising the polycrystalline cubic boron nitride, PCBN, material in accordance with the first aspect of the invention.

Preferable and/or optional features of the second aspect of the invention are provided in dependent claims 8 to 13.

In a third aspect of the invention, there is provided a method of fabricating a polycrystalline cubic boron nitride, PCBN, composite material, said method comprising the steps:
providing a matrix precursor powder comprising one or more superalloys;
providing a cubic boron nitride, cBN, powder comprising particles of cBN,
mixing the matrix precursor powder and the cBN powder;
compacting the mixed matrix precursor powder and cBN powder to form a green body;
outgassing the green body under a vacuum and at a temperature of between 800° C. and 1100° C.;
sintering the green body at a temperature of between 1300° C. and 1600° C. and a pressure of at least 3.5 GPa to form the PCBN material in accordance with the first aspect of the invention.

Preferable and/or optional features of the third aspect of the invention are provided in dependent claims 15 to 17.

### BRIEF DESCRIPTION OF THE DRAWING

The invention will now be more particularly described, by way of example only, with reference to the accompanying drawings, in which:

FIG. 1 shows a partial side view of a FSW tool;

FIG. 2 is a side view of a tool assembly comprising the tool insert of FIG. 1, a tool holder and a locking collar securing the tool insert to the tool holder;

FIG. 3 is a flow diagram showing an example method of making a sintered PCBN composite material in accordance with the invention;

FIG. 4 is an X-ray diffraction trace (XRD) of a composite material in one embodiment of the invention;

FIG. 5 is a scanning electron microscopy (SEM) micrograph of the microstructure of the material of FIG. 4, taken at a magnification of 10,000×;

FIG. 6 is an SEM micrograph of the microstructure of the material of FIG. 5 at a second location, again taken at a magnification of 10,000×;

FIG. 7 is a simplified schematic of a second embodiment of a FSW tool; and

FIG. 8 is a simplified schematic of the tool of FIG. 7 mounted in a tool assembly.

Similar parts use similar references.

### DETAILED DESCRIPTION OF THE DRAWINGS

Geometry

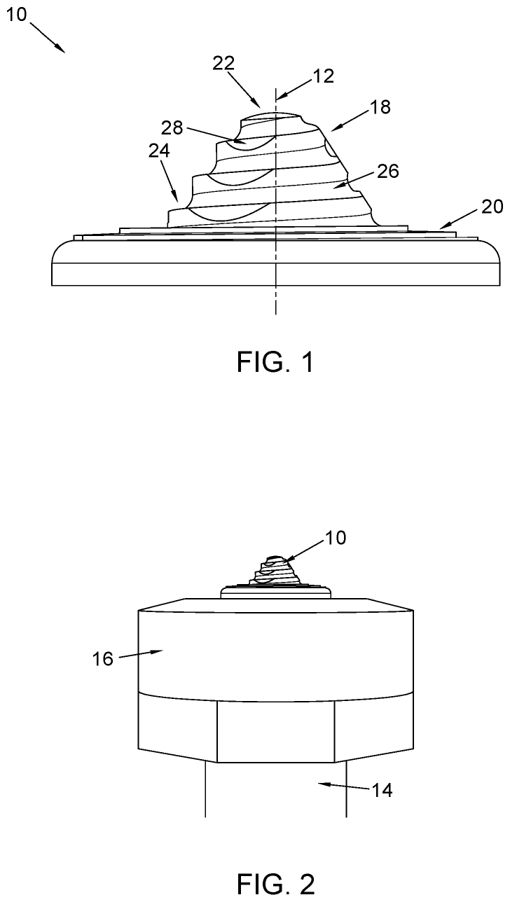

Referring to FIGS. 1 and 2, an FSW tool insert is indicated generally at 10. The tool insert 10 has an axis of rotation 12 about which it rotates during FSW. (Note that this axis of rotation is not an axis of rotational symmetry, largely because of the asymmetric thread pattern machined into the tool insert.) In use, the tool insert 10 is shrunk fit into a tool holder 14. A locking collar 16 secures the tool insert 10 in place in the tool holder 14. Note that this is an example of a common type of a tool holder, but that the invention is independent of the type of tool holder used.

The tool insert 10 comprises a stirring pin 18, a shoulder 20 and a body portion (not shown), all in axial alignment with each other. The stirring pin 18, shoulder 20 and body portion are all integrally formed with each other.

The stirring pin 18 extends from a rounded apex 22 to the shoulder 20. In this embodiment, the shoulder 20 is substantially cylindrical and has a larger diameter than a circular base of the stirring pin 18. The stirring pin 18 has an inscribed spiral feature running from the apex 22 down to the shoulder 20. As such, the stirring pin 18 is generally conical in profile. The spiral has a planar pathway 24, which faces axially. In use, the rotation of the tool is such that the spiral drives workpiece material flow from the edge of the shoulder 20 to the centre and then down the length of the stirring pin 18, forcing workpiece material to circulate within the stirred zone and to fill the void formed by the pin as the tool traverses. Such circulation is understood to promote homogeneous microstructure in the resulting weld. The working surface 26 of the tool insert 10 faces radially.

Several tri-flats 28 are provided in the spiral. Each tri-flat 28 is an edge chamfer of the planar pathway 24. In this example, three sets of tri-flats 28 are provided, each set having three tri-flats 28, making nine tri-flats 28 in total for this particular tool 10. The sets are spaced apart by approximately 120 degrees about the axis of rotation 12. Within each set, the tri-flats 28 are axially spaced apart on the spiral, i.e. spaced apart along the axis of rotation 12 but still on the spiral.

The shoulder 20 extends axially to meet the body portion. The body portion is configured to couple with the tool holder 14. An example of a tool holder and a correspondingly shaped tool is provided in the Applicant's co-pending patent application GB2579915. For example, the body portion may have a hexagonal lateral cross-section.

Composition

In terms of material, the tool insert 10 comprises a PCBN composite material. The composite material may comprise between 70 and 95 vol. % cubic boron nitride, cBN, particles and between 30 and 5 vol. % binder matrix material in which the cBN particles are dispersed. In this embodiment, the composite material comprises 80 vol. % cBN particles and 20 vol. % binder matrix material.

The binder matrix material comprises one or more superalloys. Superalloys, or high performance alloys, are commonly understood to be alloys the exhibit excellent mechanical strength and creep resistance at high temperatures, good surface stability, and corrosion and oxidation resistance.

These alloys derive high temperature strength from a combination of mechanisms which include the precipitation and dispersion of discrete carbide and oxide particles, the retention of a heavily worked molybdenum matrix and solid solution strengthening.

Superalloys typically have an austenitic face-centred cubic crystal structure with a base alloying element of cobalt, nickel, iron or nickel-iron.

In this embodiment, the binder matrix material comprises a single superalloy, TZM (Ti—Zr—Mo). The composition of the binder matrix material is 99.4% Mo-0.5% Ti-0.08% Zr-0.02% C.

In another embodiment, the binder matrix material comprises two or more superalloys.

The binder matrix material also includes aluminium(Al) in a form other than as an oxide. The aluminium may be provided in a quantity of between 0.5 and 10 wt. % of the binder matrix material. The aluminium promotes a liquid phase during sintering.

Optionally, the binder matrix material also includes a tungsten rhenium mixture (W—Re) in addition to the above-mentioned binder matrix materials. The quantity of rhenium in the tungsten-rhenium mixture can be reduced and replaced in part by one or more superalloys, thereby reducing the cost of the composite material whilst retaining the necessary performance characteristics.

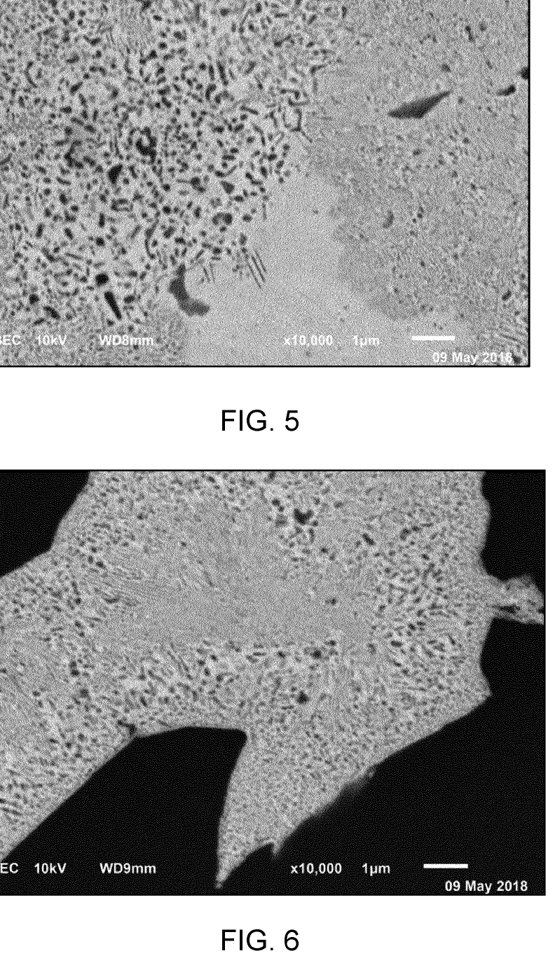

An XRD trace for the composite material is provided in FIG. 4. FIGS. 5 and 6 show nanocrystalline precipitates in the binder, found to include: titanium oxides, zirconium oxides, and aluminium oxides, and combination such as ZrxAlyOz; TixAly, TixAlyNz, AlN, Mo2B, B2Zr, ZrxNy, TiB2, TiN, AlxMoy, MoxTiy, AlxMoyTiz, BxTiyZrz, AlB2, AlB12, MoxTiyZrz, MoxNy.

Method

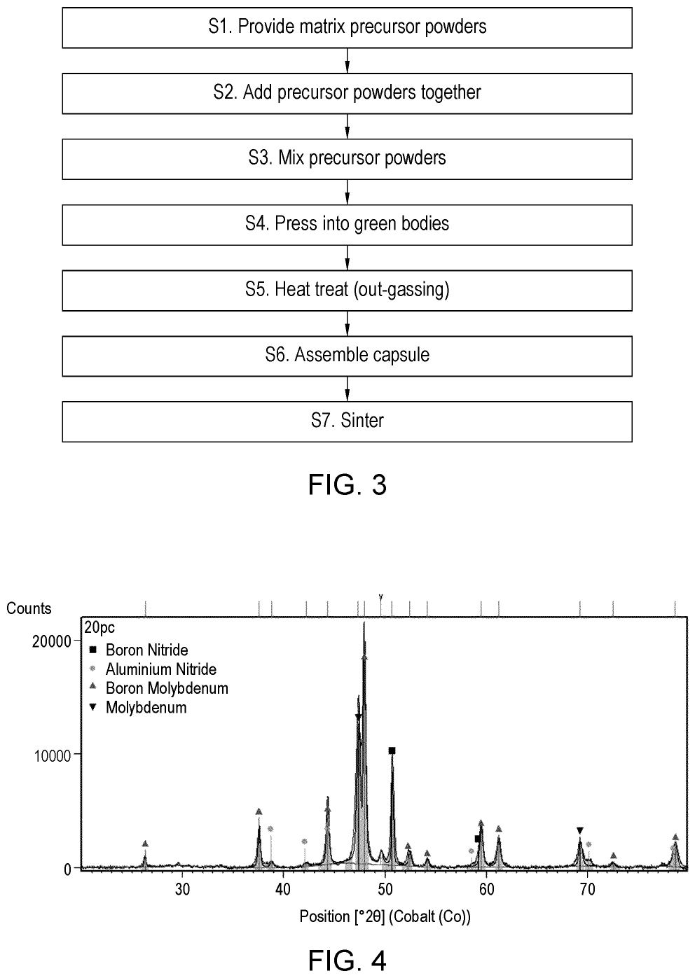

FIG. 3 shows an exemplary method for producing the above-described sintered tool insert PCBN composite material. The following steps refer to FIG. 3.

S1. Matrix precursor powders were provided in a cBN to binder volume percent ratio of 80:20.

S2. Matrix precursor powders were added together. cBN powder was added to powder comprising superalloy, TZM (Ti—Zr—Mo). The composition of the binder matrix material is 99.4% Mo-0.5%Ti-0.08%Zr-0.02%C. The size distribution of the cBN may be mono-modal or multi-modal (including bi-modal).

S3. Matrix precursor powders were mixed together.

The precursor powders were mixed together using a SpeedMixer™, which is a bladeless dry powder mixer. The advantage of using this route is that, unlike attrition milling, impurities from milling media are avoided. Attrition milling is conventionally used not only to break down the matrix precursor particles to a desired size, but also to intimately mix and disperse the matrix precursor particles and the cBN particles. Attrition milling is usually performed with tungsten carbide balls. A sintered PCBN material, producing using attrition milling, can contain up to 8 wt. % tungsten carbide, typically 2 wt. % to 6 wt. % tungsten carbide. These particles are known to have a detrimental effect on the properties of the PCBN material, particularly in applications such as hard part turning. Furthermore, the tungsten carbide pickup during attrition milling is not controlled, so different batches may contain different amounts of tungsten carbide with different size distributions, leading to unpredictable performance of the sintered PCBN material when used in a tool application.

Another advantage of this route is that there is no crushing of cBN grains. The effect is that sintered cBN grains within the composite material have a greater sharpness than those sintered after attrition milling. The sharpness may also enhance material integrity and toughness. Sharpness is explained in more detail below.

Additionally, a bladeless mixing route reduces the reactivity of the precursor powders so that they are safer to handle. Lastly, with higher purity precursor powders (significantly less contamination), the sintered PCBN is stronger.

The grain sharpness may be used as an indicator of the mixing route used since the sharpness of the cBN grains pre-and post-sintering is primarily determined by the mixing route. Using a bladeless dry mixer mix produces cBN grains with a different grain sharpness compared to those shaped by attrition milling.

It is envisaged that ultrasonic mixing in a solvent or dry acoustic mixing may be used as an alternative to bladeless mixing described above. As such, the level of impurities found in the sintered composite material is less than 4 wt. %, and may be less than 3 wt. %, or 2 wt. %, or 1 wt. %. Even though tungsten carbide impurities can be avoided, there may still be trace amounts of iron impurities stemming from the raw precursor powders.

Bladeless mixing, ultrasonic mixing and dry acoustic mixing all offer a faster and more efficient way of mixing compared to attrition milling, with the benefit that the time taken to prepare the sintered PCBN material is greatly reduced.

S4. The mixed powders were then pressed into green bodies. Pre-compaction is necessary to ensure that there is a minimal change in volume during the final sintering. If density is not maximised before sintering, then increased shrinkage may lead to a decrease in pressure while sintering, resulting in conversion of cBN to hexagonal boron nitride (hBN) and cracking of the samples.

S5. The green body was introduced into an enclosure, also known as a “can”, formed from a refractory metal such as niobium. The can containing the mixture was then placed in a vacuum furnace (Torvac) and subjected to elevated temperature conditions under vacuum. This step removes excess oxygen from the mixture, and subsequently aids sintering. Outgassing was performed at a temperature of between 900° C. and 1150° C. Outgassing is an important factor in achieving a high density in the finished composite material. Without outgassing, the sintering quality is poor. Outgassing is often carried out overnight, for a minimum of 8 hours depending on the quantity of material being outgassed.

S6. After outgassing, the can was sealed whilst still in the outgassing conditions, and the can containing the mixture subsequently placed within a HPHT capsule.

S7. The can containing the mixture was then subject to high pressure and high temperature condition for full sintering. The sintering temperature was between 1300° C. and 1600° C., whilst the pressure was at least 3.5 GPa. The sintering pressure is usually in the range of 4.0 to 6.0 GPa, preferably between 5.0 and 5.5 GPa. The sintering temperature is preferably around 1500° C. Full sintering forms a polycrystalline material comprising particles of cBN dispersed in a matrix material.

After the sintering process, the pressure was gradually reduced to ambient conditions. The fully sintered composite material was left to cool to room temperature and subsequently shaped into a tool suitable for friction stir welding.

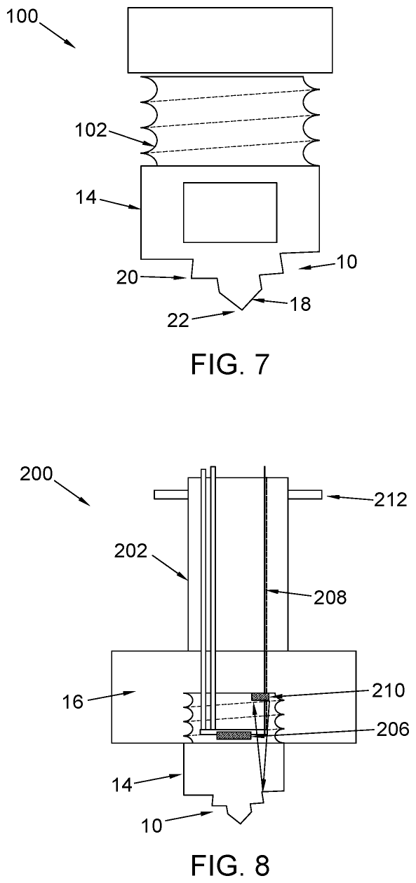

FIG. 7 shows a second embodiment of a tool 100, which is very similar to the tool in the first embodiment but a backing element 102 is joined to the tool holder 14, making the tool 100 ‘backed’. A full description of the tool 100 is therefore omitted to avoid repetition and only the differences are described.

In this embodiment, the tool holder 14 is cylindrical with circular ends. The backing element 102 is bonded to the one end of the tool holder 14, remote from the stirring pin 18. Bonding may be diffusion bonding. The backing element 102 comprises a PCBN composite material, in which the binder comprises one or more superalloys, for example Alloy 718 (common trade name: Inconel® 718). Alloy 718 is a nickel-chromium-molybdenum alloy, which exhibits exceptionally high yield, tensile and creep-rupture properties at high temperatures.

Referring to FIG. 8, a tool assembly is indicated generally at 200. The tool assembly 200 comprises an elongate tool post 202, the tool 100 described above with reference to FIG. 7 and a locking collar 16. The tool assembly 200 has a longitudinal axis of rotation. The locking collar 16 is mounted concentrically about the tool post 202 and the backing element 102 to secure the tool post 202 and the tool 100 in axial alignment. The backing element 102 therefore helps to connect the tool holder 14 to the tool post 202. The backing element 102 also plays a more significant role in heat transfer to the rest of the FSW machine.

The tool assembly optionally comprises a temperature sensor 206 mounted at or near the interface between the backing element 102 and the locking collar 16. The temperature sensor 206 is preferably a platinum type resistance temperature display (RTD), which is very sensitive to changes in the temperature.

To cool down the tool assembly 200, optional cooling channels 208 extend through the tool post 202 and the backing element 102.

Optional wear monitoring 210 on the cutting tool is possible using ultrasonic reflectometry, where a transceiver uses signals to monitor tool wear in real-time.

Tool assembly wobbling, also known as run-out, is monitored using optional eddy current sensors 212. The sensors 212 monitor the position of the tool 100 and hence any increase in the wobbling. A feedback loop is used to control the operating parameters of the tool assembly 200 to maximise tool life.

The operating temperature of the tool 100, its wear and the tool assembly 200 run-out are all key factors that, without optimisation, may lead to catastrophic failure of the assembly 200.

While this invention has been particularly shown and described with reference to embodiments, it will be understood by those skilled in the art that various changes in form and detail may be made without departing from the scope of the invention as defined by the appended claims.

1. A polycrystalline cubic boron nitride, PCBN, composite material comprising:
between 70 and 95 vol. % cubic boron nitride, cBN, particles and
between 30 and 5 vol. % binder matrix material in which the cBN particles are dispersed,
the binder matrix material comprising one or more superalloys.

2. The PCBN composite material as claimed in claim 1, in which the superalloy is Ti—Zr—Mo.

3. The PCBN composite material as claimed in claim 1, the binder matrix material further comprising a tungsten-rhenium mixture.

4. The PCBN composite material as claimed in claim 3, in which the binder matrix material comprises 70 to 80 wt. % tungsten, 15 to 30 wt. % rhenium and 0.1 to 15 wt. % superalloy.

5. The PCBN composite material as claimed in claim 4, in which the binder matrix material comprises 75 wt. % tungsten, 20 wt. % rhenium and 5 wt. % superalloy.

6. The PCBN composite material as claimed in claim 1, the binder matrix material further comprising aluminium in a form other than an as oxide.

7. The PCBN composite material as claimed in claim 6, wherein the aluminium in a form other than as an oxide is present in a quantity between 5 and 10 wt. % of the binder matrix material.

8. A tool for friction stir welding, said tool comprising a body portion comprising the polycrystalline cubic boron nitride, PCBN, material as claimed in claim 1.

9. The tool as claimed in claim 8, further comprising a backing portion joined at a first end to the body portion.

10. The tool as claimed in claim 9, in which the backing portion comprises a second superalloy which is different to the first said superalloy.

11. The tool as claimed in claim 10, in which the second superalloy is a nickel-chromium-molybdenum alloy.

12. The tool as claimed in claim 9, in which the backing portion is adapted at a second end to be joined to a tool holder.

13. The tool as claimed in claim 12, in which the second end comprises a screw thread.

14. A method of fabricating a polycrystalline cubic boron nitride, PCBN, composite material, said method comprising the steps:
providing a matrix precursor powder comprising one or more superalloys;
providing a cubic boron nitride, cBN, powder comprising particles of cBN,
mixing the matrix precursor powder and the cBN powder;
compacting the mixed matrix precursor powder and cBN powder to form a green body;
outgassing the green body under a vacuum and at a temperature of between 800° C. and 1100° C.;
sintering the green body at a temperature of between 1300° C. and 1600° C. and a pressure of at least 3.5 GPa to form the PCBN composite material of claim 1.

15. The method as claimed in claim 14, in which the composite material is as claimed in claim 2.

16. The method as claimed in claim 14, further comprising the step of adding aluminium powder to the matrix precursor powder.

17. The method as claimed in claim 14, further comprising the step of adding tungsten-rhenium mixture to the matrix precursor powder.
